(19) United States
(12) Patent Application Publication
(10) Pub. No.: US 2009/0276504 A1
(43) Pub. Date: Nov. 5, 2009

(54) DYNAMIC NETWORKING SYSTEM

(75) Inventor: Kenneth L. Gavranovic, Douglasville, GA (US)

Correspondence Address: BRYAN W. BOCKHOP, ESQ.;BOCKHOP & ASSOCIATES, LLC, 2375 MOSSY BRANCH DR., SNELLVILLE, GA, 30078, US

(73) Assignee: WEBSINGULARITY, INC., Atlanta, GA (US)

(21) Appl. No.: 12/114,987

(22) Filed: May 5, 2008

(51) Int. Cl. G06F 15/16

(52) U.S. Cl. 709/218

(57) ABSTRACT

In a method of managing interactions between a first entity and a second entity, an indication of information requirements that the first entity requires from the second entity to establish a link is received from the first entity. The second entity transmits: a first set of information corresponding to the information requirements, an indication that the second entity desires to establish the link, and an indication of desired information that the second entity requests from the first entity. A link is established between the first entity and the second entity. Once the link has been established, the first set of information is transmitted to the first entity; a second set of information is received from the first entity, the second set of information corresponding to the desired information; the second set of information is transmitted to the second entity; updated information corresponding to updates to the second set of information are received from the first entity; and the updated information is transmitted to the second entity.

### BACKGROUND OF THE INVENTION

1. Field of the Invention

The present invention relates to social networking systems and, more specifically, to a social networking system that allows participants to control the conditions under which they interact with other participants.

2. Description of the Prior Art

On-line social networking systems enable people to provide information to each other electronically. Typically, a user of a social networking system will post information onto the system. Such information could include contact information, information about personal interests, job skill information, advertising information and the like. Many social networking systems allow users to link to each other by sending e-mail invitations. Once linked, one user typically will have access to all of the other user's posted information. It is possible to restrict access to certain subsets of a user's posted information to certain users. However, most social networking systems do not provide users with detailed control over how their information is disseminated.

Creating a link between two entities in a social networking system usually involves the sending of an e-mail from a first entity to a second entity, the second entity logging onto a system in response thereto and then entering an indication of a desire to link to the first entity. This can be a cumbersome process that might discourage an entity from linking to a large number of other entities.

Some on-line systems also provide business directories. Sometimes they even provide the ability for users to write reviews about businesses. However, such reviews only provide information about how those who are motivated to review a business feel about the business. They do not provide information about how the general consuming public views the business.

Many people keep electronic calendars. Certain organizations also maintain on-line calendars with entries that are of interest to people associated with the organizations. When a person who is associated with an organization wishes a date on the organization's calendar to be included on his own calendar, he usually has to enter the date manually on his calendar.

Therefore, there is a need for a social networking system that facilitates easy exchange of information among its members and that allows its members to control the conditions under which it shares information with other members.

### SUMMARY OF THE INVENTION

The disadvantages of the prior art are overcome by the present invention which, in one aspect, is a method, operable on a computer network, of managing interactions between a first entity and a second entity. An indication of information requirements that the first entity requires from the second entity to establish a link between the first entity and the second entity is received from the first entity. The system receives from the second entity: a first set of information corresponding to the information requirements, an indication that the second entity desires to establish the link, and an indication of desired information that the second entity requests from the first entity. A link is established between the first entity and the second entity upon receiving the first set of information and the indication that the second entity desires to establish the link. Once the link has been established, the following actions are performed: the first set of information is transmitted to the first entity; a second set of information is received from the first entity, the second set of information corresponding to the desired information; the second set of information is transmitted to the second entity; updated information corresponding to updates to the second set of information are received from the first entity; and the updated information is transmitted to the second entity.

In another aspect, the invention is a method, operable on a computer network, for establishing a relationship between a first entity and a second entity in a social network. An access code is associated with a set of predefined relationship parameters. The relationship parameters define at least a first set of information that will be collected by the first entity from the second entity and a second set of information that will be provided by the first entity to the second entity when a connection is established between the first entity and the second entity. An electronic message that includes the access code is received from the second entity. The second set of data is received from the first entity. The first entity is associated with the second entity upon receiving the message that includes the access code so that the first entity and the second entity are associated according to the predefined relationship parameters. The first set of information is accessed. The first set of information is transmitted to the first entity upon associating the first entity with the second entity. The second set of information is transmitted to the second entity upon associating the first entity with the second entity.

In another aspect, the invention is a method, operable on a computerized network system, of creating a reference network. An information set is received from a first entity. The first entity is linked to a plurality of consumer entities, including a first consumer entity. A second consumer entity is linked to the first consumer entity. An indication is received from the second consumer entity of a desire to acquire information that meets a set of criteria set forth by the second consumer entity. Entities linked to the first consumer entity are searched for information sets that meet the set of criteria set forth by the second consumer entity. An information set from the first entity is provided to the second consumer entity if the information set meets the criteria set forth by the second consumer entity. Data indicative of linking activity between the first entity and the plurality of consumer entities is transmitted to at least one of the plurality of consumer entities.

In another aspect, the invention is a method, operable on a computer network, of sharing calendar information, in which an online calendar is maintained for a first entity and another online calendar is maintained for a second entity. A designation of a elected set of information from the calendar maintained for the first entity that the first entity will allow to be shared with the second entity is received from the first entity. An indication that the second entity desires the selected set of information from the calendar maintained by the first entity is received from the second entity. The selected set of information is overlaid onto the calendar maintained for the second entity.

In another aspect, the invention is a method, operable on a computerized network system, for providing information about business entities of a plurality of business entities to a plurality of consumer entities. Input is received from each consumer entity of the plurality of consumer entities. The input is indicative of which of the business entities of the plurality of business entities that the consumer entity has selected to link to. Each consumer entity of the plurality of consumer entities is linked to each business entity indicated by the consumer entity. A first consumer entity of the plurality of consumer entities is linked to a subset of the plurality of consumer entities selected by the first consumer entity via a first social network. A request for information about business entities meeting at least one criterion is received from the first consumer entity. Information regarding each business entity that meets the criterion and than is linked to a consumer entity of the subset of the plurality of consumer entities to which the first consumer entity is linked is displayed to the first consumer entity,

In yet another aspect, the invention is a digital computer system that operates with a global computer network. A processor is in communication with the global computer network. A digital storage medium includes a program residing thereon that is configured to cause the processor to execute a series of actions. An account is created for a first entity and a second entity. An indication of information requirements that the first entity requires from the second entity to establish a link between the first entity and the second entity is received from the first entity. A link is established between the first entity and the second entity when the second entity indicates that it desires to establish the link and when the second entity indicates that the system has permission to satisfy the information requirements. Information satisfying the information requirements is transmitted to the first entity once the link has been established. A set of information received from the first entity is transmitted to the second entity once the link has been established.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic diagram of a physical embodiment of a dynamic social networking system.

FIG. 2 is a flow chart demonstrating a method of creating a link between two entities.

FIG. 3 is a schematic diagram showing a relationship between a facilitator and two entities.

FIG. 4 is a schematic diagram showing one exemplary network space.

FIGS. 5A-5C are a schematic diagrams demonstrating a calendar overlay system.

FIGS. 6 is a schematic diagram of a system for linking consumer entities to business entities via a plurality of social networks.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Also, as used herein, “global computer network” includes the Internet and a “digital storage medium” includes any physical medium (including, but not limited to, CD-ROM's, disk drives, computer memory chips, etc.) capable of storing digital data.

One embodiment of the invention is an on-line networking system in which a plurality of entities (including individuals, businesses and other organizations) participate. Each entity maintains a profile of information regarding the entity. This information may include several different categories, including: basic information (for example: name, birth date, ethnicity, telephone number, e-mail address, and other demographic information); work experience; education; hobbies and interests (including: religious affiliation, groups the entity is a member of, favorite books, and languages spoken by the entity, etc.).

The entity can also set relationship parameters as to how information may be shared with other entities. For example, the entity can designate certain parts of the profile as generally publicly available to other entities and other parts as available only under certain circumstances. Relationship parameters can also include security parameters and watch parameters.

Once the profile is entered, the entity can seek out connections (also referred to herein as “links”) with other entities. Upon seeking a connection, the entity specifies what information it requires from the other in order to create a connection between the two entities. If the other entity agrees to share the required information, and in return be provided information from another entity, a connection is created, thereby causing the information to be shared. For example, if one entity is a restaurant and the other is an individual, the restaurant might require the individual's demographic information and the individual might require information about the restaurant's menu and periodic specials that it offers. If both entities are willing to share the information required by the other, then the system creates the connection and transfers the desired information between the entities.

Each entity can categorize, or tag, the other entity upon such connection. Each entity can create information and specify which tagged connections can see such information. Such a transfer can be ongoing. For example, a restaurant might create content containing weekly specials that are tagged as visible to the individual, which would allow the individual to see the information.

To facilitate connections, an entity may create an alpha-numeric code (referred to as a “PIMcode”) that is recognized by the system as being associated with a predefined set of connection criteria. For example, a restaurant might create the code “EATATJOES” and include the EATATJOES PIMcode in its advertising. An entity interested in the restaurant could access the system on-line, via e-mail (or via text message through a cellular telephone) and enter “EATATJOES.” If the entity's profile authorizes the sharing of information requirement associated with the “EATATJOES” PIMcode, then the system will create a connection between the entity and the restaurant. A PIMcode could be promulgated in several ways. For example it could be included in print material, or it could be included as a button on a Web site that, once selected, automatically connects the entity to the PIMcode originator.

In one embodiment, the following steps may be followed to create and use a PIMcode: (1) A user desires to create a PIMcode and chooses a unique alphanumeric text phrase as the PIMcode; (2) The system verifies that the chosen PIMcode is indeed unique; (3) The user selects a text and an image to graphically represent the PIMcode, both of which will be displayed any time someone wants to connect with the user; (4) The user can market or publish their PIMcode any way they choose; including print; web-embedded code, which displays the graphic representing the PIMcode; or a Unique web url that represents the PIMcode; (5) The PIMcode has now been created; (6) Anyone can now reference this unique PIMcode utilizing email, web, MMS or SMS; (7) The PIMcode serves as a unique password enabling others to connect to the user utilizing a “handshake” agreement. The handshake predefines what information someone desiring to connect with the user must provide in order to establish the connection; (8) The PIMcode enables the user to internally categorize or tag the connected person once a handshake is established; (9) If someone desiring a connection to the user enters the PIMcode via the internet, they see a welcome message indicating all information that must be shared in order to connect with the user. They then have the option of providing the requisite information (and are prompted if required information is incomplete) and connecting to the user, or not providing the information and not connecting with the user; (10) Assuming the connecting user chooses to connect (tagging the owner of the PIMcode). The system creates a digital connection between the two entities sharing only the pre-agreed information. If either user subsequently chooses to disconnect from the other user, the digital connection is severed and not restored until both users agree to restore the connection (by redoing the previously described connection process); (11) As an additional layer, the owner of the PIMcode can specify in advance if they want to review the incoming connection before the digital connection is made. If this option is chosen, the connection is in waiting status, for the user trying to connect, pending approval by the owner of the PIMcode. The owner can accept the connection from the pending state or disconnect it; (12) Users can also email PIMcode or send an SMS/MMS message containing the PIMcode. When the email or SMS/MMS is received, the system starts the digital connection (the connection will remain in pending/waiting status if the PIMcode requires final approval of the connection); (13) In summary, a PIMcode is a unique identifier used to establish a connection between two users (people, groups, businesses) by defining in advance what information will be shared and how the connection will be categorized internally once the connection is established. The PIMcode can be shared any way of one's choosing, and can establish a connection utilizing the internet, email, or SMS/MMS messaging.

In one embodiment, a commercial entity is able to receive contact information from an information carrier in which the second entity holds an account as a result of the second entity transmitting the access code. For example, if a consumer enters one of a business entity's PIMcodes via a telephone network, the telephone exchange carrier will provide the consumer's telephone number to the facilitator, which will create a link between the consumer and the business if the consumer has an account with the system. If the consumer does not have an account yet, the system will associate the telephone number with the consumer's request for information and then call the telephone number to instruct the consumer on how to sign up for an account. Once the consumer creates an account, the system will then associate the consumer's request with the consumer's account and then provide the consumer with the requested information. A similar process will happen with on-line requests, where the system uses the consumer's URL as a basis for contacting the consumer.

One mode of operation is to provide an electronic yellow pages-type directory. Certain entities, such as businesses, can enter business-related information in their profiles. For example, a restaurant could enter into its profile information that designates it as a restaurant and information about what type of restaurant it is. An entity could then search this information using desired search criteria.

The system also allows an entity to access the businesses that the entity's connected entities are also connected to. For example, an entity could see which restaurants his friends are connected to and could then connect to the listed restaurants.

Any entity can disconnect any connection with any other entity at any time. This gives entities the ability to maintain a dynamic network of connections. In the business context, the entity may maintain a dynamic service directory of products and services. For example, an entity can initially connect to a restaurant using the “EATATJOES” PIMcode, but after a bad experience with the restaurant the entity can disconnect the restaurant from his network.

The system can rank certain entities (such as businesses) based on a count of the number of entities that are currently connected to the entity. For example, if many entities maintain a connection to a first restaurant and only a few entities maintain a connection to a second restaurant, then the first restaurant would be ranked higher than the second restaurant. The system may also record information about connections and provide that information to interested entities. For example, the system could calculate the average duration of a connection maintained between a restaurant and the entities connected to it. This information could be used by the restaurant to see how it is doing in different demographics. It could also be used by entities to assess how well the restaurant is liked. Other types of data could also be mined regarding the number of connections maintained between entities, the trend in number of entities, the demographics of connections, etc.

Each entity can maintain a calendar on his account. An entity may also allow calendar entries from selected other entities' calendars to be overlaid onto his calendar to create a comprehensive view. For example, an entity could select to overlay an individual and a restaurant's calendar. The entity would then be able to see all the events that the individual and the restaurant allow the entity to see.

Each event on a calendar is tagged to determine which entities can see the event. An entity seeking information from another entity's calendar can view only events where the tag the on the event from the creator matches the way the creator has tagged the entity. For example, if entity A is a goalie for a soccer team, he may have been tagged only “Team” by ENTITY B. If entity B has created a calendar event that only entities tagged “friend” can see, then ENTITY A cannot see the calendar event. If Entity B has created another event tagged as “Team,” then ENTITY A could see it. An entity's calendar view, including any overlays, may also be exported to other systems, such as Outlook.

The system also includes a feature that allows an entity to draft reviews and comments about other entities and share those comments. For example, entities could enter reviews of a restaurant, which could be made generally available to other entities. The entity can also specify who can see such information by putting a visibility tag on the content. Only entities with a matching visibility tag could see the information.

The system also provides a search ability that allows the entity to see which other entities meet predetermined criteria and then allow the entity to try to connect to these entities. The system also allows entities to invite people outside of the system to join the system and form a connection.

In one embodiment of a dynamic business directory, an entity identifies and categorizes itself (a service provider entry) in a method that describes the category of services it offers, a brief description, and a method of contacting it (PIMcode, email, website, phone number). Entities can digitally connect to users via a PIMcode, enabling them to share agreed information. An entity may then choose to create a dynamic services directory. The dynamic service directory is created by enabling a search of all service provider entries that a user is connected to and all service provider entries for the direct connections of their direct connections. In one embodiment, a search by the top entity sees any and all service provider pages that any of these entities have, even though the top entity does not have a direct connection to the entities at bottom. While no direct connection to the person doing the search, service providers connected to these entities show up in the dynamic directory search through the shared connection.

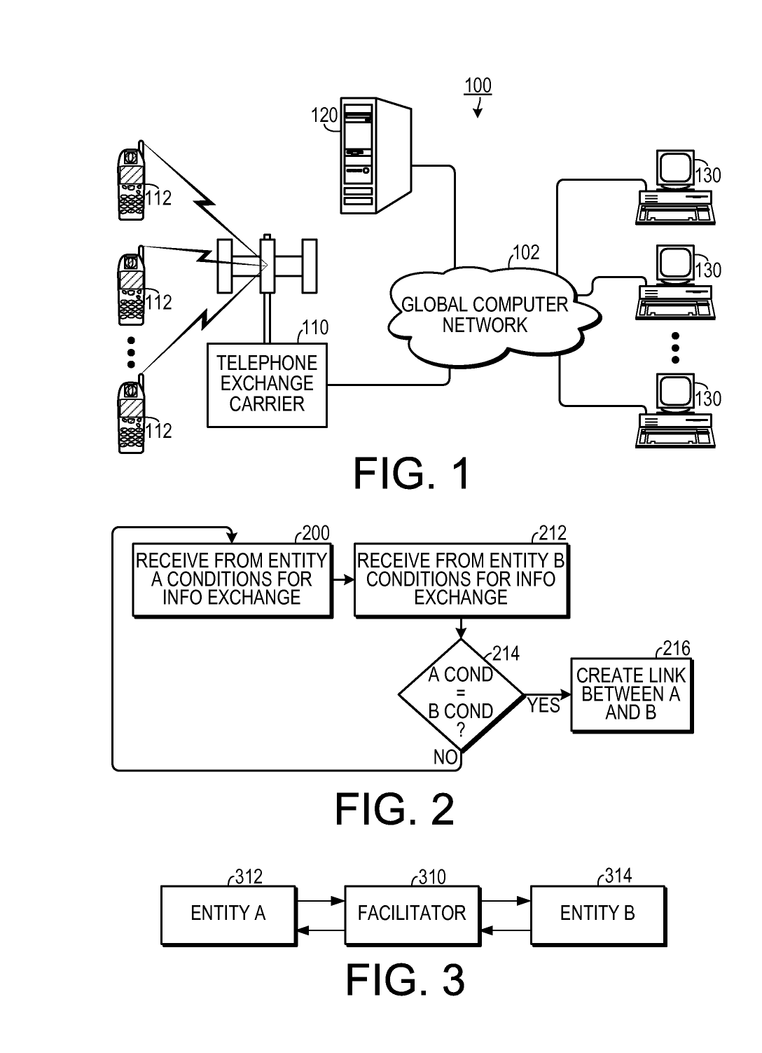

As shown in FIG. 1, one physical embodiment of a dynamic social networking system 100 employs a central server 120, which includes a processor and a digital storage medium, in communication with a global computer network 102. The central server 120 is programmed to act as a facilitator for exchanging information between a plurality of different entities. Such entities could include, for example, businesses, consumers, organizations, members of organizations, etc. When an entity creates an account with the system, it sends to the central server 120 a set of information that is specific to the entity. For example, it could transmit such information as: name, address, gender, a photograph, events to be maintained on a calendar, a description of services, etc. Each entity can also tag information items to indicate to which other entities, or types of entities, it is willing to share an information item. The entities can communicate with the central server 120, for example, via a computer 130 or a telephone 112 (via a telephone exchange carrier 110), which are also in communication with the global computer network 102.

As shown in FIG. 2, the system receives from a first entity an indication of the conditions it requires to be met (e.g., the information it seeks) and the conditions it is willing to meet (e.g., the information it is willing to share) in order to create an information exchange 200. The system also receives from a second entity a similar set of conditions 212. The system determines if the first entity's conditions match the second entity's conditions 214 and, if they do, it creates a link between the two entities 216, thereby sharing the desired information.

As shown in FIG. 3, the system acts as a facilitator 310 between the entities 312 and 314. (While only two entities are shown in this figure, it should be understood that many entities would interact with the facilitator 310.) Thus, each entity 312 and 314 would send information to the facilitator 310, which evaluates whether the conditions are present for an information exchange. If they are, the facilitator 310 sends out the information to the entities 312 and 314.

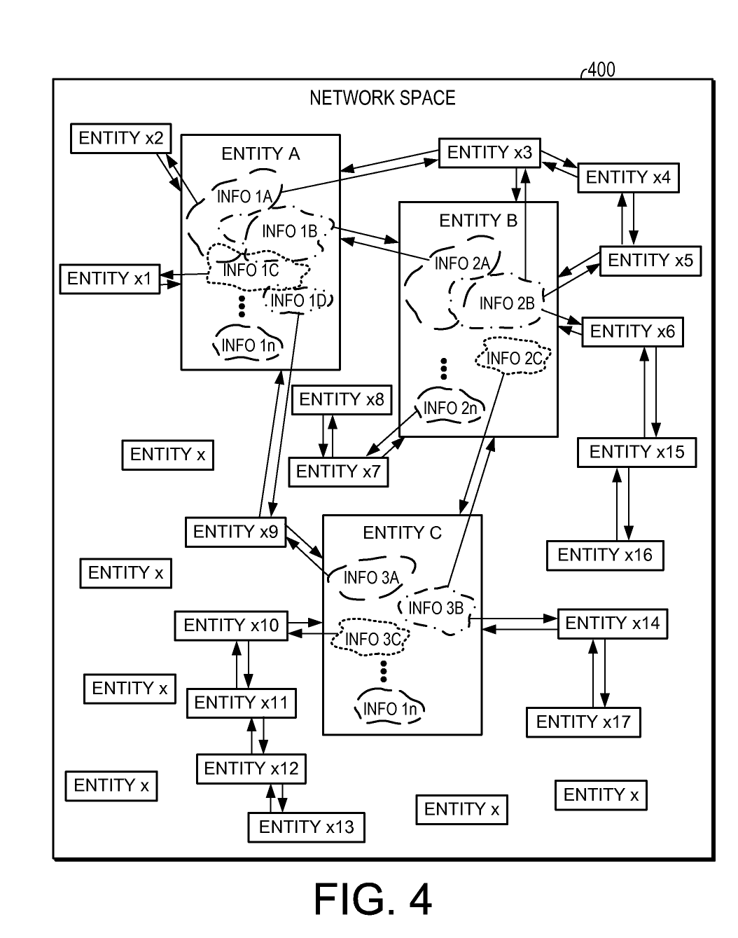

An example of a network space 400 that could be created using the invention is shown in FIG. 4. The network space 400 shows many different entities that have accounts with the facilitator. Each entity maintains a set of information associated with its account, and the set of information may be subdivided into different groupings. For example, Entity A maintains the following groupings of information: Info 1A, Info 1B, Info 1C, Info 1D, etc. Some of the groupings might overlap; for example, Info 1A and Info 1B overlap extensively. One possible example of the type of information maintained by Entity A, which could be a business, could be that Info 1A includes information that Entity A is willing to share with vendors, Info 1B includes information that Entity A is willing to share with premium customers, Info 1C includes information that Entity A is willing to share with the general public, etc. If Entity A is willing to share its telephone number with all of the entities to which it is connected, then the overlapped groupings would each include the telephone number.

In the example shown, Entity A is willing to share the information subset Info 1B with Entity B and Entity B is willing to share the information subset Info 2A with Entity A. The system then creates a connection between Entity A and Entity B and shares the desired information.

In one example, Entity A could be a restaurant and Entities B and C could be consumers who are linked to each other as friends. If Entity C is looking for a restaurant, it could enter its search criteria and the system could provide an opportunity for Entity C to connect to Entity A if Entity A meets the search criteria. The system could also provide Entity C with information regarding the number of other entities connected to Entity A and the average amount of time an entity maintains a connection to Entity A.

In one embodiment, the system can record the duration of a digital connection between two entities and can calculate the average duration of an entity's connections. The system can compare this average to the average duration of a comparative subset (e.g. restaurants in Atlanta vs. restaurants in Boston, lawyers in New York vs. lawyers in Birmingham, my connections vs. . . . , etc.) and rank it a number from 1 to n (number entities).

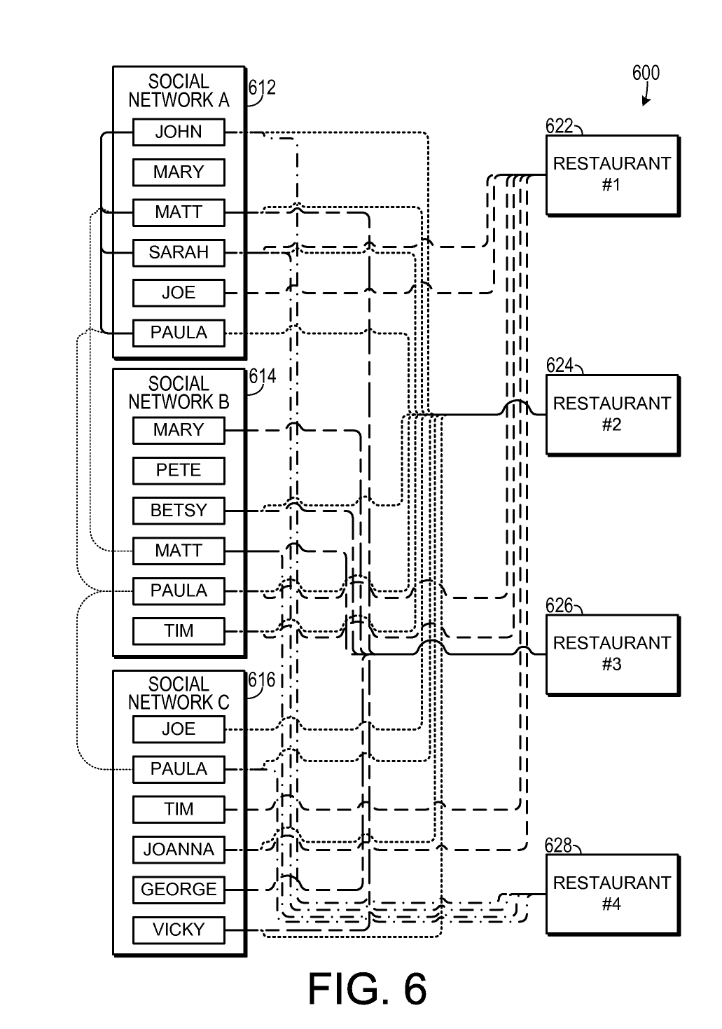

In one embodiment, as shown in FIG. 6, a plurality of consumer entities (which might be natural persons or entities such as organizations that consume products or services) are members of social networks 612, 614, 616 (such as, e.g., MySpace, Facebook, LinkedIn, etc.). Various members of the social networks 612, 614, 616 are linked to each other within a given social network. For example, John (a consumer entity) in Social Network A 612 is linked to Matt and Paula via Social Network A 612.

Each entity in any of the social networks 612, 614, 616 is capable of selectively linking to one or more business entities 622, 624, 626, 628 (such as, e.g., restaurants). Each of the business entities 622, 624, 626, 628 may have different criteria associated with them. For example, Restaurant No. 1 622 might be an Indian restaurant, Restaurant No. 2 624 might be a Chinese restaurant, Restaurant No. 3 626 might be an Indian Restaurant, and Restaurant No. 4 628 might also be an Indian restaurant.

The system allows each member of a social network to generate queries that set forth various criteria regarding the type of business entity that the member seeks information on. In response, the system will display information about each entity that meets the member's criteria and that is linked to another entity to which the member is linked. The system can also retrieve information across more than one social network.

For example, John might desire a recommendation for a good Indian restaurant. He submits a query for an Indian restaurant. The system sees that Matt is linked to the following two Indian restaurants: Restaurant No. 3 626 and Restaurant No. 4 628; Sarah is linked to Restaurant No. 1 622 and Restaurant No. 4 628; and Paula is linked to Restaurant No. 1 622 and Restaurant 4 628. Therefore, in response to John's query, the system displays to John Restaurants Nos. 1 622, 3 626 and 4 628. Also, since three of the individuals linked to John are also linked to Restaurant No. 4 628, two are linked to Restaurant No. 1 622 and only one is linked to Restaurant No. 3 626, the system will display Restaurant No. 4 628 at the top of the list and Restaurant No. 3 626 at the bottom of the list.

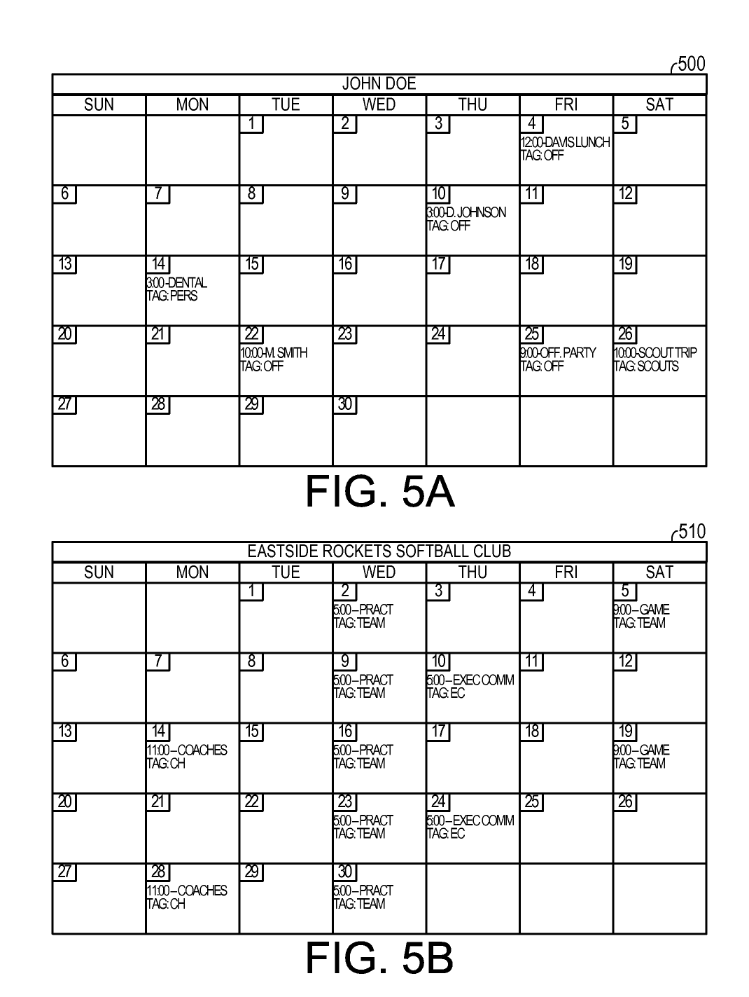

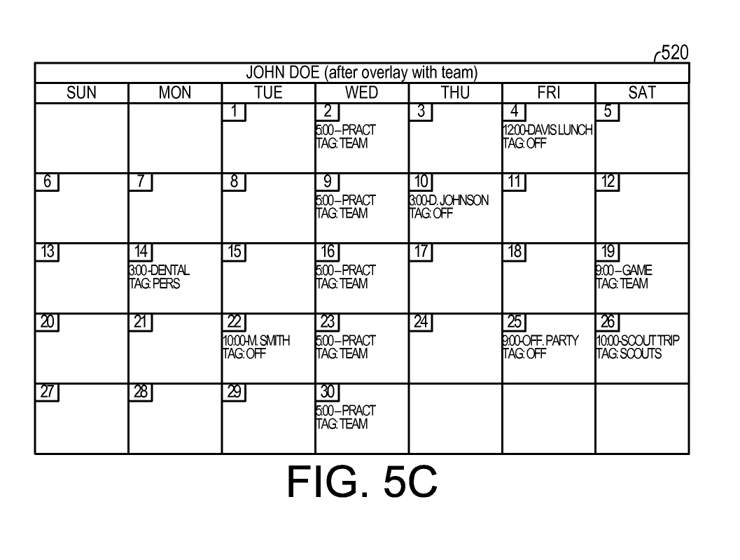

The calendar overlay capability is demonstrated in FIGS. 5A-5C. An individual's calendar 500 is shown in FIG. 5A. This individual is a member of a softball team, whose calendar 510 is shown in FIG. 5B. The team's calendar 510 includes entries of interest to the team members, such as the practice every Wednesday at 5:00 and the games occurring on the fifth and the nineteenth of the month. The team calendar also contains entries that are not of interest to the team members, such as the coaches meetings on the fourteenth and the twenty-eighth of the month and the executive committee meetings occurring on the tenth and the twenty-fourth of the month. Since these events are tagged for the individuals with whom the system may share the events, the system can overlay all of the events tagged for team members onto the team member's calendar 520, as shown in FIG. 5C. Also, the system can overlay changes to a first entity's calendar onto a second entity's calendar as they are made. For example, if a meeting is added onto the first entity's calendar, the will be added onto the second entity's calendar if the meeting is tagged to allow it to be shared with the second entity. Similarly, if the meeting is deleted from the first entity's calendar, it can be automatically deleted from the second entity's calendar, without any action on the part of the second entity.

In one embodiment of a shared calendaring system, an entity connects to other entities (person, groups, businesses) and tags (creates multiple folders) on the entity. The entity enters data and selects which tags (folders) can see this content. If an entity is tagged the same as the content then they can see the content, otherwise it is not seen.

At any time, any entity can break a link with another entity. Indicating to the facilitator the desire to break a link causes the facilitator to break the link. This gives the subscribing entities the power to decide exactly with whom they wish to link.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method, operable on a computer network, of managing interactions between a first entity and a second entity, comprising the steps of:
a. receiving from the first entity an indication of information requirements that the first entity requires from the second entity to establish a link between the first entity and the second entity;
b. receiving from the second entity: a first set of information corresponding to the information requirements, an indication that the second entity desires to establish the link, and an indication of desired information that the second entity requests from the first entity;
c. establishing a link between the first entity and the second entity upon receiving the first set of information and the indication that the second entity desires to establish the link; and
d. once the link has been established, performing the following actions:
i. transmitting the first set of information to the first entity;
ii. receiving a second set of information from the first entity, the second set of information corresponding to the desired information;
iii. transmitting the second set of information to the second entity;
iv. receiving updated information corresponding to updates to the second set of information from the first entity; and
v. transmitting the updated information to the second entity.

2. The method of claim 1, further comprising the actions of:
a. receiving from at least one of the first entity or the second entity and indication of a desire to break the link; and
b. breaking the link.

3. The method of claim 1, wherein the second set of information includes information about an event, including a date on which the event is to occur, the method further comprising the action of delivering event information directly to an electronic calendar maintained by the second entity.

4. The method of claim 1, further comprising the actions of:
a. associating a code with the information requirements that the first entity requires from the second entity to establish a link between the first entity and the second entity;
b. receiving the code from the second entity via a carrier with which the second entity holds an account; and
c. acquiring the information required by the first entity from the carrier.

5. The method of claim 1, further comprising the actions of:
a. establishing links between the first entity and a plurality of consumer entities; and
b. providing a third entity with data indicative of linking activity between the first entity and the plurality of consumer entities to at least one of the plurality of consumer entities.

6. The method of claim 5, wherein the data indicative of linking activity includes data indicative of how many consumer entities are linked to the first entity.

7. The method of claim 5, wherein the data indicative of linking activity includes data indicative of an average length of time that a consumer entity is linked to the first entity.

8. The method of claim 1, further comprising the actions of:
a. receiving from a first consumer entity an instruction to disconnect the first consumer entity from the first entity; and
b. disestablish the link between the first consumer entity and the first entity.

9. A method, operable on a computer network, for establishing a relationship between a first entity and a second entity in a social network, comprising the actions of:
a. associating an access code with a set of predefined relationship parameters, the relationship parameters defining at least a first set of information that will be collected by the first entity from the second entity and a second set of information that will be provided by the first entity to the second entity when a connection is established between the first entity and the second entity;
b. receiving from the second entity an electronic message that includes the access code;
c. receiving from the first entity the second set of data;
d. associating the first entity with the second entity upon receiving the message that includes the access code so that the first entity and the second entity are associated according to the predefined relationship parameters;
e. accessing the first set of information;
f. transmitting the first set of information to the first entity upon associating the first entity with the second entity; and
g. transmitting the second set of information to the second entity upon associating the first entity with the second entity.

10. The method of claim 9, further comprising the action of receiving from the first entity the set of predefined relationship parameters.

11. The method of claim 9, wherein the action of accessing the first set of information comprises the actions of:
a. receiving contact information from an information carrier in which the second entity holds an account as a result of the second entity transmitting the access code;
b. associating the contact information with the first set of information;
c. contacting the second entity using the contact information and inviting the second entity to create an account in the social network so that the account includes the contact information; and
d. if the contact information in the account in the social network corresponds to the contact information associated with the first set of information, then transmitting the first set of information to the second entity.

12. The method of claim 11, wherein the contact information comprises a telephone number.

13. The method of claim 11, wherein the contact information comprises a uniform resource locator.

14. The method of claim 9, wherein the set of predefined relationship parameters are selected from a group of parameters consisting of: security parameters, watch parameters, and combinations thereof.

15. The method of claim 9, wherein the first entity and the second entity each maintain a calendar, the method further comprising the actions of:
a. receiving from the first entity a designation of a elected set of information from the calendar maintained by the first entity that the first entity will allow to be shared with the second entity;
b. receiving from the second entity an indication that the second entity desires the selected set of information from the calendar maintained by the first entity; and
c. overlaying the selected set of information onto the calendar maintained by the second entity.

16. A method, operable on a computerized network system, of creating a reference network, comprising the actions of:
a. receiving an information set from a first entity;
b. linking the first entity to a plurality of consumer entities, including a first consumer entity;
c. linking a second consumer entity to the first consumer entity;
d. receiving an indication from the second consumer entity of a desire to acquire information that meets a set of criteria set forth by the second consumer entity;
e. searching entities linked to the first consumer entity for information sets that meet the set of criteria set forth by the second consumer entity
f. providing an information set from the first entity to the second consumer entity if the information set meets the criteria set forth by the second consumer entity; and
g. transmitting data indicative of linking activity between the first entity and the plurality of consumer entities to at least one of the plurality of consumer entities.

17. The method of claim 16, wherein the data indicative of linking activity includes data indicative of how many consumer entities are linked to the first entity.

18. The method of claim 16, wherein the data indicative of linking activity includes data indicative of an average length of time that a consumer entity is linked to the first entity.

19. The method of claim 16, wherein the first entity comprises a business establishment.

20. The method of claim 16, further comprising the actions of:
a. receiving from the first consumer entity an instruction to disconnect the first consumer entity from the first entity; and
b. de-linking the first consumer entity from the first entity.

21. A method, operable on a computerized network system, for providing information about business entities of a plurality of business entities to a plurality of consumer entities, comprising the actions of:
a. receiving input from each consumer entity of the plurality of consumer entities indicative of which of the business entities of the plurality of business entities that the consumer entity has selected to link to;
b. linking each consumer entity of the plurality of consumer entities to each business entity indicated by the consumer entity;
c. linking, via a first social network, a first consumer entity of the plurality of consumer entities to a subset of the plurality of consumer entities selected by the first consumer entity;
d. receiving, from the first consumer entity, a request for information about business entities meeting at least one criterion; and
e. displaying, to the first consumer entity, information regarding each business entity that meets the criterion and than is linked to a consumer entity of the subset of the plurality of consumer entities to which the first consumer entity is linked.

22. The method of claim 21, wherein at least one second consumer entity is linked to at least one target business entity via a second social network, different from the first social network, wherein if the first consumer entity is linked to the second consumer entity via the first social network and if the second consumer entity is linked to the target business entity via the second social network, and if the target business entity meets the criterion, then the displaying action will include the action of displaying information about the target business entity to the first consumer entity.

23. The method of claim 21, wherein the displaying action comprises indicating a ranking indicating which of the business entities meeting the criteria are linked to more consumer entities that are also linked to the first consumer entity.

24. A method, operable on a computer network, of sharing calendar information, comprising the actions of:
a. maintaining an online calendar for a first entity;
b. maintaining an online calendar for a second entity;
c. receiving from the first entity a designation of a elected set of information from the calendar maintained for the first entity that the first entity will allow to be shared with the second entity;
d. receiving from the second entity an indication that the second entity desires the selected set of information from the calendar maintained by the first entity; and
e. overlaying the selected set of information onto the calendar maintained for the second entity.

25. A digital computer system that operates with a global computer network, comprising:
a. a processor that is in communication with the global computer network;
b. a digital storage medium upon which resides a program configured to cause the processor to execute a series of actions, including:
i. create an account for a first entity and a second entity;
ii. receive from the first entity an indication of information requirements that the first entity requires from the second entity to establish a link between the first entity and the second entity;
iii. establish a link between the first entity and the second entity when the second entity indicates that it desires to establish the link and when the second entity indicates that the system has permission to satisfy the information requirements;
iv. transmit information satisfying the information requirements to the first entity once the link has been established; and
v. transmitting a set of information received from the first entity to the second entity once the link has been established.

26. The digital system of claim 25, wherein the program is configured to cause the processor to execute a further series of actions, including:
a. associate a code with the information requirements that the first entity requires from the second entity to establish a link between the first entity and the second entity;
b. receive the code from the second entity via a carrier with which the second entity holds an account; and
c. acquire the information required by the first entity from the carrier.

27. The digital system of claim 25, wherein the program is configured to cause the processor to execute a further series of actions, including:
a. establish links between the first entity and a plurality of consumer entities; and
b. provide a third entity with data indicative of linking activity between the first entity and the plurality of consumer entities to at least one of the plurality of consumer entities.

28. The digital system of claim 27, wherein the data indicative of linking activity includes data indicative of how many consumer entities are linked to the first entity.

29. The digital system of claim 27, wherein the data indicative of linking activity includes data indicative of an average length of time that a consumer entity is linked to the first entity.

30. The digital system of claim 25, wherein the program is configured to cause the processor to execute a further series of actions, including:
a. receive from a first consumer entity an instruction to disconnect the first consumer entity from the first entity; and
b. disestablish the link between the first consumer entity and the first entity.
